(19) United States
(12) Patent Application Publication
(10) Pub. No.: US 2026/0077803 A1
(43) Pub. Date: Mar. 19, 2026

(54) STEERING FEEDBACK ACTUATOR

(71) Applicant: HYUNDAI MOBIS CO., LTD., Seoul (KR)

(72) Inventors: Chang Wook SON, Yongin-si (KR); Jong Hun JEONG, Yongin-si (KR)

(73) Assignee: HYUNDAI MOBIS CO., LTD., Seoul (KR)

(21) Appl. No.: 19/280,584

(22) Filed: Jul. 25, 2025

(30) Foreign Application Priority Data
Sep. 13, 2024 (KR) 10-2024-0125760

(51) Int. Cl. B62D 5/00

(52) U.S. Cl. CPC B62D 5/006

(57) ABSTRACT

A steering feedback actuator including a housing part, a steering column part rotatably accommodated in the housing part, a first gear part coupled to the steering column part, the first gear part being configured to rotate along with the steering column part, an electric motor part including a motor housing, the motor housing being configured to be movably coupled to the housing part and to cover an opening of the housing part and a motor shaft, the motor shaft being configured to be rotatably coupled to the motor housing and including a second gear part, the second gear part configured to engage the first gear part, and a wheelbase variable member coupled to the housing part and the motor housing, the wheelbase variable member being configured to advance and retreat with respect within the housing part and to move the motor housing to vary a wheelbase between the steering column part and the motor shaft.

### CROSS-REFERENCE TO RELATED APPLICATION

This application claims priority from and the benefit under 35 USC § 119 of Korean Patent Application No. 10-2024-0125760, filed on Sep. 13, 2024, in the Korean Intellectual Property Office, the entire disclosure of which is incorporated by reference for all purposes.

### BACKGROUND

### 1. Field

Exemplary embodiments of the present disclosure relate to a steering feedback actuator, and more particularly, to a steering feedback actuator which is applied to a steer-by-wire (SBW) system.

### 2. Description of the Related Art

In general, a power steering system for a vehicle is an oil pressure type steering system which generates oil pressure by using an oil pump that is driven by power of an engine and that generates steering assistive power by the oil pressure. Such an oil pressure type steering system has disadvantages in that the oil pressure type steering system requires multiple parts and has a complex structure. Accordingly, an SBW system that transmits a driver's steering intention to a road wheel in the form of an electrical signal without a mechanical connection between a steering wheel and the road wheel is being researched and developed.

The SBW system includes a steering feedback actuator (SFA) and a road wheel actuator (RWA). When a steering wheel is rotated, an electronic control unit (ECU) of a vehicle receives a steering angle as an electrical signal, and steers a road wheel by driving the RWA based on the electrical signal. The SBW system can improve driving convenience and vehicle safety because a steering ratio can be easily changed based on a driving condition of the vehicle.

A conventional steering feedback actuator includes a reducer and a motor. The reducer includes a worm reducer, a belt type reducer, and a planet gear reducer. Such a reducer has problems in that production costs are high and there is a good possibility that a quality problem may occur because the reducer has a complicated mechanism in view of its structural characteristics. Furthermore, there are problems in that noise according to the gear backlash of the reducer may occur and there is a difficulty in securing backlash setting precision due to a limited reduction of the pitch of a screw thread when wheelbase is adjusted. Accordingly, there is a need to improve such problems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a steering feedback actuator including a housing part, a steering column part rotatably accommodated in the housing part, a first gear part coupled to the steering column part, the first gear part being configured to rotate along with the steering column part, an electric motor part including a motor housing, the motor housing being configured to be movably coupled to the housing part and to cover an opening of the housing part and a motor shaft, the motor shaft being configured to be rotatably coupled to the motor housing and including a second gear part, the second gear part configured to engage the first gear part, and a wheelbase variable member coupled to the housing part and the motor housing, the wheelbase variable member being configured to advance and retreat with respect within the housing part and to move the motor housing to vary a wheelbase between the steering column part and the motor shaft.

A first central axis of the steering column part may be disposed in a first direction parallel to a first axial direction, a second central axis of the motor shaft may be disposed in a second direction parallel to a second axial direction, and the first direction may not be within a same axial line as the second axial direction.

The first central axis may be configured to be spaced apart from the second central axis in a third direction.

A third central axis of the wheelbase variable member may be disposed in a fourth direction parallel to a fifth direction that intersects the third direction at a crossing angle.

The crossing angle of the fifth direction with respect to the third direction may be between 10 degrees and 90 degrees.

The motor housing may include a housing body part coupled to the motor shaft, a flange part coupled to the housing body part, the flange part being configured to receive the motor shaft, and a guide protrusion part provided on the flange part, the guide protrusion part being configured to protrude from the guide protrusion part and to be inserted into the housing part to support the wheelbase variable member.

The steering feedback actuator may include a plurality of the guide protrusion parts, the plurality of the guide protrusion parts being arranged in a plural number in a circumferential direction of the flange part, the plurality of guide protrusion part being spaced apart from each other.

The housing part may include a movement restriction recess formed in an inner surface of the housing part, the movement restriction recess being configured to accommodate the guide protrusion part and to limit a movement of the guide protrusion part.

The housing part may further include a plurality of movement restriction recesses disposed at locations respectively corresponding to the plurality of guide protrusion parts.

The first gear part may be one of a plastic material or a metal material and the second gear part may be a plastic material.

### BRIEF DESCRIPTION OF THE DRAWINGS

FIG. 1 is a perspective view of a steering feedback actuator, which is viewed in one direction, according to an embodiment of the present disclosure.

FIG. 2 is a perspective view of the steering feedback actuator of FIG. 1, which is viewed in another direction.

FIG. 3 is a one-side cross-sectional view schematically illustrating the steering feedback actuator according to an embodiment of the present disclosure.

FIG. 4 is a partially enlarged cross-sectional view schematically illustrating the steering feedback actuator according to an embodiment of the present disclosure.

FIG. 5 is a partially enlarged perspective view schematically illustrating the steering feedback actuator according to an embodiment of the present disclosure.

FIG. 6 is a cross-sectional view schematically illustrating the steering feedback actuator according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

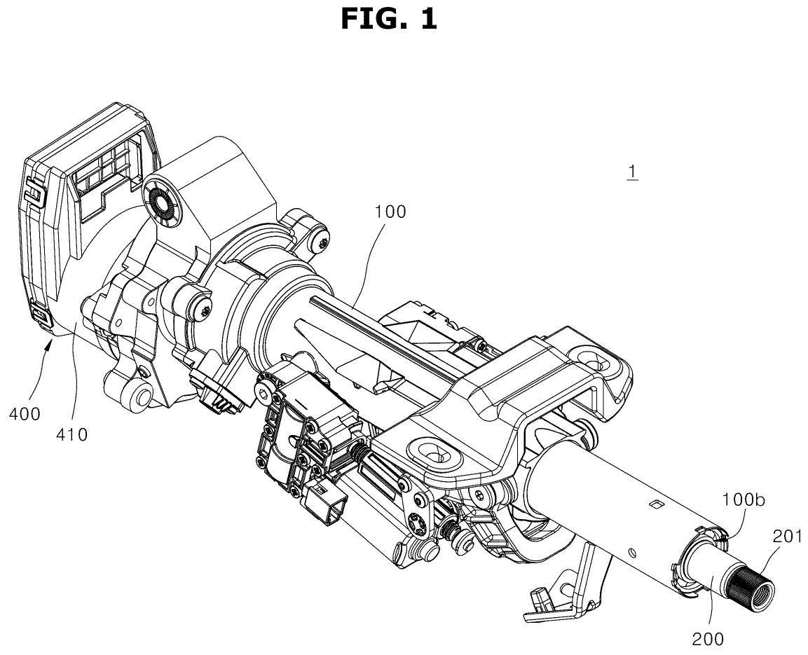

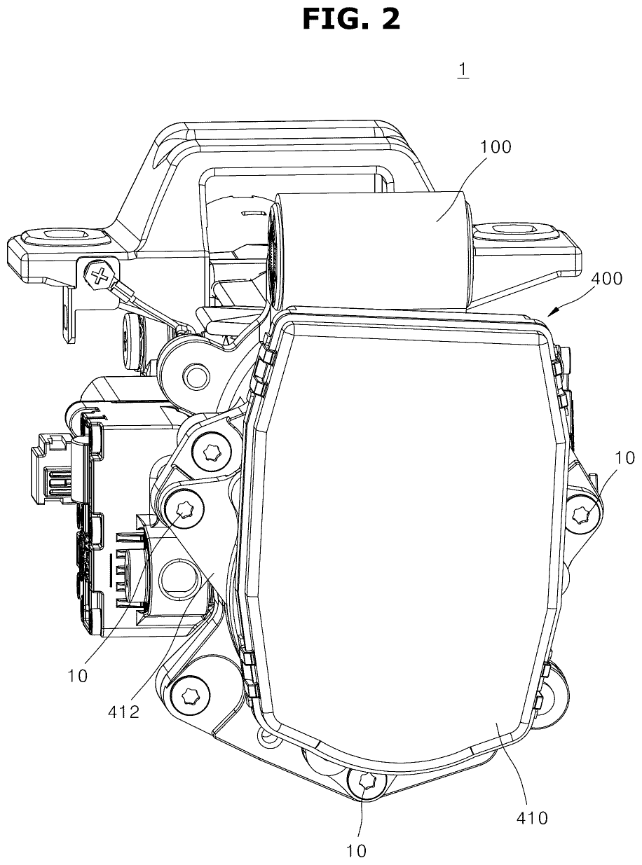

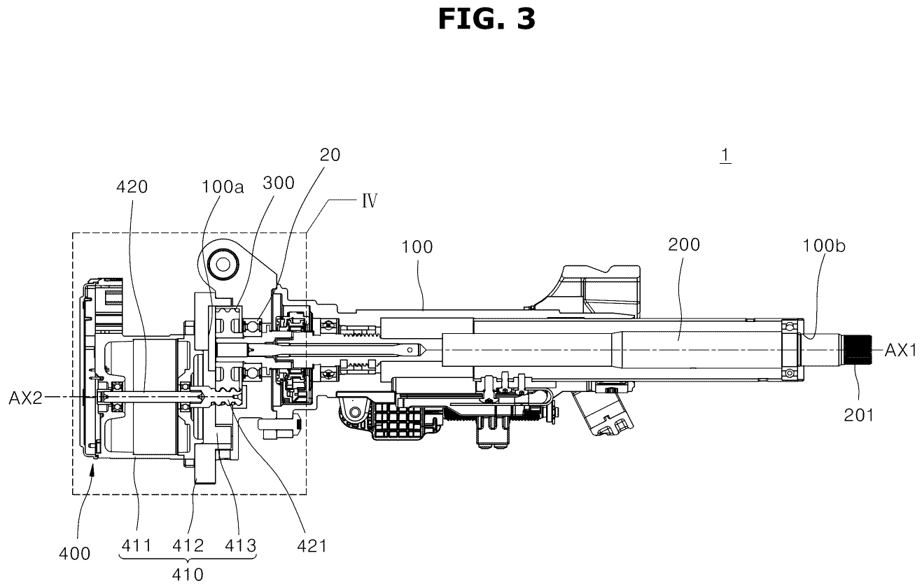

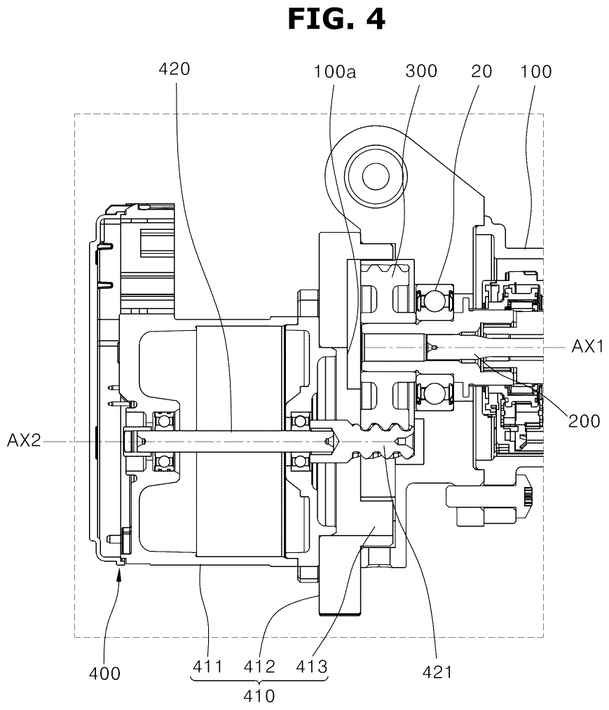

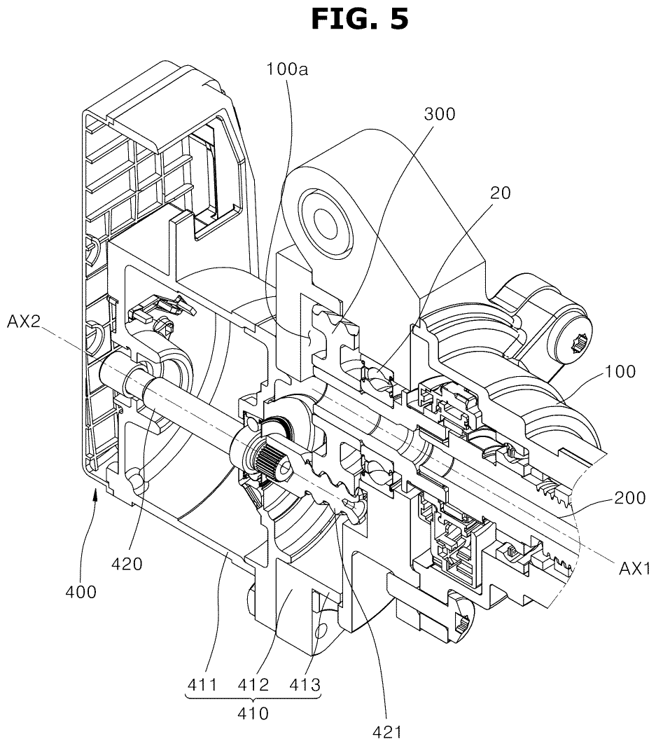

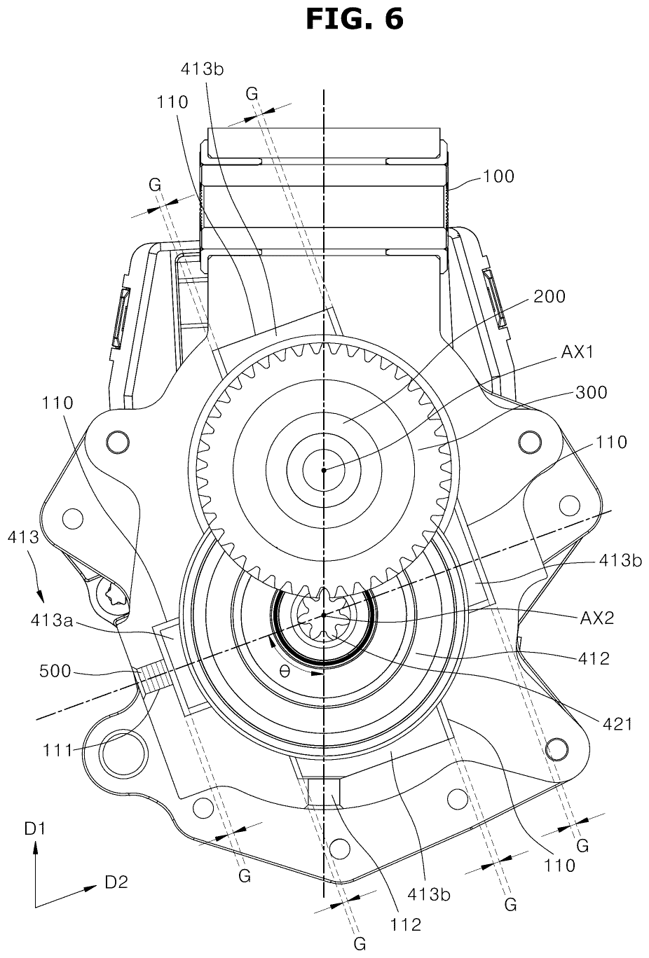

FIG. 1 is a perspective view of a steering feedback actuator, which is viewed in one direction, according to an embodiment of the present disclosure. FIG. 2 is a perspective view of the steering feedback actuator of FIG. 1, which is viewed in another direction. FIG. 3 is a one-side cross-sectional view schematically illustrating the steering feedback actuator according to an embodiment of the present disclosure. FIG. 4 is a partially enlarged cross-sectional view schematically illustrating the steering feedback actuator according to an embodiment of the present disclosure. FIG. 5 is a partially enlarged perspective view schematically illustrating the steering feedback actuator according to an embodiment of the present disclosure. FIG. 6 is a cross-sectional view schematically illustrating the steering feedback actuator according to an embodiment of the present disclosure.

Referring to FIGS. 1 to 6, the steering feedback actuator 1 according to an embodiment of the present disclosure includes a housing part 100, a steering column part 200, a first gear part 300, an electric motor part 400, and a wheelbase variable member 500, which are described in detail as follows.

The housing part 100 may form a rough appearance of the steering feedback actuator 1 according to an embodiment of the present disclosure, and may generally support the steering column part 200, the first gear part 300, the electric motor part 400, and the wheelbase variable member 500.

A detailed shape of the housing part 100 is not limited to the shape illustrated in FIG. 1, and may be variously designed and changed within the technical spirit of a shape capable of generally supporting the components of the steering feedback actuator 1 according to an embodiment of the present disclosure.

The housing part 100 may be formed to have a cylindrical shape with a hollow interior. The steering column part 200 may be accommodated within the housing part 100.

Both sides of the housing part 100 in a length direction thereof may be opened. An opening 100a may be provided on one side (i.e., the left side of FIG. 3) of the housing part 100 in the length direction, which faces the electric motor part 400. The opening 100a may be formed through one side of the housing part 100 in the length direction of the housing part 100.

A through hole 100b may be formed on the other side (i.e., the right side of FIG. 3) of the housing part 100 in the length direction. The through hole 100b may be formed through the other side of the housing part 100 in the length direction of the housing part 100. One side (i.e., the right side of FIG. 3) of the steering column part 200 may be exposed from the housing part 100 through the through hole 100b.

The steering column part 200 may be installed within the housing part 100 in a way to be axially rotated. The steering column part 200 may be disposed in a direction parallel to the length direction of the housing part 100.

The central axis of the steering column part 200 may be disposed in a direction parallel to a first axial direction AX1. The direction of the central axis of the steering column part 200 and the first axial direction AX1 may be disposed on the same axial line.

Accordingly, the first axial direction AX1 may be the same direction as the length direction of the housing part 100. Furthermore, the first axial direction AX1 may be the same direction as the direction of the central axis of the steering column part 200.

A spline 201 may be provided on one side of the steering column part 200, which is exposed through the through hole 100b formed on the other side of the housing part 100 in the length direction thereof. The spline 201 may be formed on the outer circumferential surface of the steering column part 200.

A steering wheel (not illustrated) may be coupled to one side of the steering column part 200 in which the spline 201 is formed. Accordingly, the steering column part 200 may be axially rotated in line with the rotation of the steering wheel.

A bearing 20 that rotatably supports the steering column part 200 may be accommodated within the housing part 100. The bearing 20 may be installed between the housing part 100 and the steering column part 200. The bearing 20 may be disposed in a plural number in the length direction of the housing part 100 so that the plurality of bearings is spaced apart from each other.

The first gear part 300 may be coupled to the steering column part 200. The first gear part 300 may be coupled to the other side (i.e., the other side of FIG. 3) of the steering column part 200, which is directed toward a direction in which the opening 100a formed on one side of the housing part 100 in the length direction thereof is disposed.

The steering column part 200 may be axially coupled to the first gear part 300. The other side of the steering column part 200 may be axially coupled to the central part of the first gear part 300.

The first gear part 300 may be rotated along with the steering column part 200. The first gear part 300 may be rotated in the same direction of the rotation direction of the steering column part 200. The first gear part 300 may include a helical gear.

The first gear part 300 may be fabricated to include a plastic material. In another embodiment, the first gear part 300 may be fabricated to include a metal material, such as steel.

The electric motor part 400 may be coupled to the housing part 100. The electric motor part 400 may generate torque by receiving power from the outside. The electric motor part 400 converts power received from the outside, such as an AC, DC, or BLDC motor, into torque, and may generate feedback in a direction in which the rotation of the steering column part 200 according to the rotation of the steering wheel is blocked.

A driver who turns the steering wheel can feel a change in a steering direction in his or her hand through the feedback that is generated by the electric motor part 400.

The electric motor part 400 may include a motor housing 410 and a motor shaft 420.

The motor housing 410 may be movably coupled to the housing part 100. Furthermore, the motor housing 410 may be moved in a radial direction thereof in the moving direction of the wheelbase variable member 500.

The motor housing 410 may be coupled to one side of the housing part 100 in the length direction thereof, in which the opening 100a is formed.

The motor housing 410 may face one side of the housing part 100 in the length direction thereof, and may cover the opening 100a of the housing part 100.

The motor housing 410 may be coupled to the housing part 100, and may be disposed in a direction parallel to the length direction of the housing part 100.

The motor housing 410 may include a housing body part 411, a flange part 412, and a guide protrusion part 413.

The housing body part 411 may form a rough appearance of the motor housing 410 according to the present embodiment, and may generally support the flange part 412, the guide protrusion part 413, and the motor shaft 420.

A detailed shape of the housing body part 411 is not limited to the shape illustrated in FIG. 3, and may be variously designed and changed.

The motor shaft 420 may be coupled to the housing body part 411. The motor shaft 420 may be coupled to the housing body part 411 in a way to be axially rotatable.

The flange part 412 may be provided in the housing body part 411. The flange part 412 may be disposed to face the opening 100a of the housing part 100, which faces a direction in which the motor housing 410 is disposed.

The flange part 412 may be coupled to an edge of the housing body part 411 by bolting. The flange part 412 may be formed to have a hollow shape in which the flange part is formed in the circumferential direction of the housing body part 411. The motor shaft 420 may pass through the inside of the flange part 412.

A tap hole may be provided in the flange part 412. The tap hole may be formed through the thickness direction of the flange part 412.

The tap hole of the flange part 412 may be disposed in a plural number in the circumferential direction of the flange part 412 so that the plurality of tap holes is spaced apart from each other. At least three tap holes may be formed in the flange part 412.

The fastening member 10 may be fastened to the housing part 100 through the tap holes formed in the flange part 412. The fastening member 10 may be a bolt that is helically coupled to the housing part 100, for example.

The motor housing 410 may be fixed to the housing part 100 because the fastening member 10 is helically coupled to the tap holes formed in the housing part 100 through the tap holes of the flange part 412.

The guide protrusion part 413 may be formed in the flange part 412 in a way to protrude therefrom. The guide protrusion part 413 may extend from the flange part 412 to a direction in which the housing part 100 is disposed. The guide protrusion part 413 may be inserted into the housing part 100 through the opening 100a of the housing part 100.

The guide protrusion part 413 may be disposed in a plural number in the circumferential direction of the flange part 412 so that the plurality of guide protrusion part is spaced apart from each other. Any one of the plurality of guide protrusion parts 413 may be supported by the wheelbase variable member 500.

A movement of the guide protrusion part 413 that is not supported by the wheelbase variable member 500 may be restricted by a moving restriction part 110.

The guide protrusion part 413 may include a first guide protrusion part 413a that comes into contact with the wheelbase variable member 500 and that is supported by the wheelbase variable member 500 and a second guide protrusion part 413b that does not come into contact with the wheelbase variable member 500 and that is not supported by the wheelbase variable member 500.

A movement of the second guide protrusion part 413b may be restricted by the moving restriction part 110. A movement of the first guide protrusion part 413a may also be restricted by the moving restriction part 110.

The motor shaft 420 may be rotatably coupled to the motor housing 410. The motor shaft 420 may be accommodated within the housing body part 411 in a way to be axially rotatable.

The central axis of the motor shaft 420 may be disposed in a direction parallel to a second axial direction AX2. The second axial direction AX2 may not accord with the first axial direction AX1. The first axial direction AX1 and the second axial direction AX2 may refer to directions that are parallel to each other without being placed on the same axial line.

The central axis direction of the motor shaft 420 and the second axial direction AX2 may be disposed on the same axial line. Furthermore, the second axial direction AX2 may be the same direction as the central axis direction of the motor shaft 420.

The motor shaft 420 may be inserted into the housing part 100 through the opening 100a of the housing part 100.

The motor shaft 420 may be spaced apart from the steering column part 200 and may be disposed in parallel to the steering column part 200. The central axis of the steering column part 200 may be disposed to be spaced apart from the central axis of the motor shaft 420 in a first direction D1.

The first direction D1 may refer to the direction of the wheelbase between the central axis of the steering column part 200 and the central axis of the motor shaft 420. Furthermore, the first direction D1 may refer to a direction in which the central axis of the steering column part 200 and the central axis of the motor shaft 420, which are disposed in parallel, become close to each other and a direction in which the central axis of the steering column part 200 and the central axis of the motor shaft 420, which are disposed in parallel, become distant from each other.

A second gear part 421 that is engaged with the first gear part 300 may be provided in the motor shaft 420. The second gear part 421 may be provided on one side of the motor shaft 420, which is inserted into the housing part 100.

The second gear part 421 may be fabricated to include a metal material, such as steel. The second gear part 421 may include a helical gear. The second gear part 421 may be formed integrally with the motor shaft 420.

A moving restriction part 110 that restricts a movement of the guide protrusion part 413 may be provided in the housing part 100. The moving restriction part 110 may be placed on the side of the opening 100a of the housing part 100. The moving restriction part 110 may be depressed and formed in an inner surface of the housing part 100 so that the guide protrusion part 413 is accommodated. For example, the moving restriction part 110 may be defined as a groove, depression, recess, or other indentation on the inner surface of the housing part 100. The moving restriction part 110 may also be referred to as a movement restriction recess.

The moving restriction part 110 may be disposed in a plural number in the circumferential direction of the housing part 100 so that the plurality of moving restriction part is spaced apart from each other. The moving restriction parts 110 may be disposed at locations corresponding to the plurality of guide protrusion parts 413.

A first through hole part 111 may be provided in the moving restriction part 110. The first through hole part 111 may be formed in a second direction D2 through the outer circumferential surface of the housing part 100. The second direction D2 may refer to a direction that intersects the first direction D1 at a set angle.

A screw thread that is formed on the inner circumferential surface of the housing part 100 may be provided in the first through hole part 111.

A gap G may be formed between the guide protrusion part 413 and the moving restriction part 110 so that the motor housing 410 is moved in a direction parallel to the second direction D2.

The wheelbase variable member 500 may be coupled to the housing part 100 in a manner that allows it to move forward and backward. Furthermore, the wheelbase variable member 500 may be helically coupled to the inner circumferential surface of the first through hole part 111 formed in the moving restriction part 110.

The wheelbase variable member 500 may be disposed in the second direction D2. The central axis of the wheelbase variable member 500 may be disposed in a direction parallel to the second direction D2 that intersects the first direction D1 at a set angle θ.

A crossing angle θ of the second direction D2 with respect to the first direction D1 may be 10 degrees to 90 degrees. Furthermore, a tilt angle θ of the wheelbase variable member 500 toward the second direction D2 on the basis of the first direction D1 in which the central axis of the steering column part 200 and the central axis of the motor shaft 420 are connected may be 10 degrees to 90 degrees.

The crossing angle θ of the second direction D2 with respect to the first direction D1 may be set, if necessary, within the angle range of 10 degrees to 90 degrees. In an embodiment, the crossing angle θ may range from 60 degrees to 85 degrees.

The wheelbase variable member 500 may support the first guide protrusion part 413a after passing through the first through hole part 111 and coming into contact with the first guide protrusion part 413a. The wheelbase variable member 500 may be a bolt, for example.

The wheelbase variable member 500 may vary the wheelbase between the steering column part 200 and the motor shaft 420 by enabling a movement of the motor housing 410.

The wheelbase between the steering column part 200 and the motor shaft 420 may be varied in the rotation direction of the wheelbase variable member 500.

As the motor housing 410 is rotated in the second direction D2, the wheelbase between the steering column part 200 and the motor shaft 420 may be varied.

The wheelbase variable member 500 pressurizes the first guide protrusion part 413a, after the motor housing 410 is assembled with the housing part 100 by helically coupling the fastening member 10 that passes through the tap hole formed in the flange part 412 to the tap hole formed in the housing part 100 and then the wheelbase variable member 500 that is helically coupled to the first through hole part 111 formed in the housing part 100 and that supports the first guide protrusion part 413a of the guide protrusion part 413 is rotated in one direction.

The first guide protrusion part 413a pressurized by the wheelbase variable member 500 and the second guide protrusion part 413b are guided by the moving restriction part 110 and moved in the second direction D2 in which the steering column part 200 is disposed. Accordingly, the wheelbase between the central axis of the steering column part 200 and the central axis of the motor shaft 420 is adjusted. As a result, backlash between the first gear part 300 and the second gear part 421 can be adjusted.

As the motor housing 410 is moved in a direction opposite to the second direction D2 or the second direction D2, the wheelbase between the steering column part 200 and the motor shaft 420 can be varied.

When the wheelbase variable member 500 that pressurizes the first guide protrusion part 413 is rotated in a reverse direction, the first guide protrusion part 413a and the second guide protrusion part 413b may be guided by the moving restriction part 110 and moved in a direction opposite to the direction in which the steering column part 200 is disposed. Accordingly, the wheelbase between the central axis of the steering column part 200 and the central axis of the motor shaft 420 can be adjusted. As a result, backlash between the first gear part 300 and the second gear part 421 can be adjusted.

A second through hole part 112 may be further provided in the housing part 100 according to the present embodiment. The second through hole part 112 may be formed on an outer surface (i.e., a lower surface in FIG. 6) of the housing part 100 in the first direction D1 in a way to penetrate the outer surface. A linear gauge may be mounted on the second through hole part 112 in order to measure a movement of the guide protrusion part 413, that is, movement of the second guide protrusion part 413b in the second direction D2.

The steering feedback actuator 1 according to an embodiment of the present disclosure can precisely adjust backlash between the first gear part 300 and the second gear part 421 because the steering feedback actuator can adjust the wheelbase between the steering column part 200 that includes the first gear part 300 and the motor shaft 420 that includes the second gear part 421 engaged with the first gear part 300 and that is disposed in parallel to the steering column part 200.

The steering feedback actuator 1 according to an embodiment of the present disclosure can reduce noise that is generated by backlash between the first gear part 300 and the second gear part 421 because the first gear part 300 includes a metal material and the second gear part 421 engaged with the first gear part 300 includes a plastic material.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A steering feedback actuator, comprising:
a housing part;
a steering column part rotatably accommodated in the housing part;
a first gear part coupled to the steering column part, the first gear part being configured to rotate along with the steering column part;
an electric motor part comprising:
a motor housing, the motor housing being configured to be movably coupled to the housing part and to cover an opening of the housing part; and
a motor shaft, the motor shaft being configured to be rotatably coupled to the motor housing and comprising a second gear part, the second gear part configured to engage the first gear part; and
a wheelbase variable member coupled to the housing part and the motor housing, the wheelbase variable member being configured to advance and retreat with respect within the housing part and to move the motor housing to vary a wheelbase between the steering column part and the motor shaft.

2. The steering feedback actuator of claim 1, wherein a first central axis of the steering column part is disposed in a first direction parallel to a first axial direction,
wherein a second central axis of the motor shaft is disposed in a second direction parallel to a second axial direction,
wherein the first direction is not within a same axial line as the second axial direction.

3. The steering feedback actuator of claim 2, wherein the first central axis is configured to be spaced apart from the second central axis in a third direction.

4. The steering feedback actuator of claim 3, wherein a third central axis of the wheelbase variable member is disposed in a fourth direction parallel to a fifth direction that intersects the third direction at a crossing angle.

5. The steering feedback actuator of claim 4, wherein the crossing angle of the fifth direction with respect to the third direction is between 10 degrees and 90 degrees.

6. The steering feedback actuator of claim 1, wherein the motor housing comprises:
a housing body part coupled to the motor shaft;
a flange part coupled to the housing body part, the flange part being configured to receive the motor shaft; and
a guide protrusion part provided on the flange part, the guide protrusion part being configured to protrude from the guide protrusion part and to be inserted into the housing part to support the wheelbase variable member.

7. The steering feedback actuator of claim 6, further comprising:
a plurality of the guide protrusion parts, the plurality of the guide protrusion parts being arranged in a plural number in a circumferential direction of the flange part, the plurality of guide protrusion part being spaced apart from each other.

8. The steering feedback actuator of claim 7, wherein the housing part includes a movement restriction recess formed in an inner surface of the housing part, the movement restriction recess being configured to accommodate the guide protrusion part and to limit a movement of the guide protrusion part.

9. The steering feedback actuator of claim 8, wherein the housing part further includes a plurality of movement restriction recesses disposed at locations respectively corresponding to the plurality of guide protrusion parts.

10. The steering feedback actuator of claim 1, wherein the first gear part comprises one of a plastic material or a metal material, and
wherein the second gear part comprises a plastic material.
